(19) United States
(12) Patent Application Publication
(10) Pub. No.: US 2007/0071099 A1
(43) Pub. Date: Mar. 29, 2007

(54) External memory device, method of storing image data for the same, and image processor using the method

(75) Inventors: Young-sup Lee, Suwon-si (KR); Jong-gu Jeon, Suwon-si (KR); Woo-sung Shim, Yongin-si (KR); Woo-seok Kang, Suwon-si (KR); Ki-won Yoo, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/519,857

(22) Filed: Sep. 13, 2006

(30) Foreign Application Priority Data
Sep. 23, 2005 (KR) 10-2005-0088678

(51) Int. Cl. H04N 7/12; H04N 11/04

(52) U.S. Cl. 375/240.12; 375/240.24

(57) ABSTRACT

An external memory device, a method of storing image data for the same, and an image processor using the method to improve an image encoding and/or decoding speed are provided. The method includes forming image data included in a predetermined-size sub-block divided from a macroblock as at least one data storage unit and storing the data storage unit in the external memory.

### CROSS-REFERENCE TO RELATED PATENT APPLICATION

This application claims priority from Korean Patent Application No. 10-2005-0088678, filed on Sep. 23, 2005, in the Korean Intellectual Property Office, the disclosure of which is incorporated herein in its entirety by reference.

### BACKGROUND OF THE INVENTION

1. Field of the Invention

Apparatuses and method consistent with the present invention relate to storing image data, and more particularly, to an external memory device, a method of storing image data for the same, and an image processor using the method to improve an image encoding and/or decoding speed.

2. Description of the Related Art

In video compression standards such as Moving Picture Expert Group (MPEG)-1, MPEG-2, MPEG-4 Visual, H.261, H.263, and H.264 standards, an input image is divided into 16×16 macroblocks. After each of the macroblocks is encoded in all encoding modes of interprediction and all encoding modes of intraprediction, bit rates required for encoding the macroblock and rate-distortion (RD) costs for the encoding modes are compared. Then an appropriate encoding mode is selected according to the results of the comparison and, the macroblock is encoded in the selected encoding mode. In interprediction, motion estimation and motion compensation are performed in units of a macroblock to reduce temporally redundant components using similarity between video frames.

FIG. 1 is a block diagram of a related art video encoder 10.

Referring to FIG. 1, the video encoder 10 includes an external memory 11, a compression unit 12, and an output buffer 13.

The external memory 11 stores an externally input image and an image of a previous frame that is reconstructed after undergoing compression encoding through the compression unit 12.

The compression unit 12 compresses an input image by performing motion estimation, motion compensation, quantization, discrete cosine transform (DCT), and entropy-encoding on the input image in units of a macroblock in interprediction. More specifically, the compression unit 12 performs motion estimation by searching in the previous frame stored in the external memory 11 for an area that is the most similar to a current macroblock and calculating a motion vector. In addition, the compression unit 12 performs motion compensation by reading the area that is the most similar to the current macroblock from the image of the previous frame stored in the external memory 11 using the calculated motion vector obtained through motion estimation and subtracting the read area from the current macroblock to generate residual data. The compression unit 12 may have embedded therein a separate local memory to store image data of a previous frame used for motion estimation and compensation, but the compression unit 12 usually reads required image data of the previous frame from the external memory 11 having a large capacity due to a limitation on the size of its embedded memory.

The output buffer 13 may be implemented with a first-in first-out (FIFO) memory and outputs the image compressed by the compression unit 12 as an output bitstream.

FIG. 2 is a view for explaining storage of image data in the external memory 11 of the video encoder 10 of FIG. 1.

Referring to FIG. 2, pixels in a row of a macroblock that is the unit of encoding or decoding are stored in a row of the external memory 11. For example, 16 pixels in a row of a macroblock are stored in a row of the external memory 11 corresponding to an address x0001_{—}0000. When the number of bits required for a single pixel is 8, 128-bit image data is stored in a row of the external memory 11.

As mentioned above, when the compression unit 12 of the video encoder 10 of FIG. 1 performs motion compensation, the compression unit 12 reads image data of a previous data indicated by a motion vector obtained through motion estimation from the external memory 11. According to the H.264 standard, a macroblock is divided into 16×8, 8×16, 8×8, or 4×4 blocks for motion compensation. In other words, each macroblock is divided into sub-blocks of various sizes for motion compensation. Such motion compensation is called tree-structured motion compensation.

When the compression unit 12 performs motion estimation and compensation on a 4×4 block using tree-structured-motion compensation, the time Tc required for reading image data of the previous frame corresponding to the 4×4 block from the external memory 11 is as follows:
Tc=(bus interface overhead processing time+transmission time)×(total number of rows read from external memory)

The bus interface overhead processing time is a latency between an access to a row of the external memory 11 and an access to another row of the external memory 11. The bus interface overhead processing time may occur when the external memory 11 is a dynamic random access memory (DRAM), a synchronous DRAM (SDRAM), or a double data rate (DDR) SDRAM. In other words, since an access to the external memory 11 is made with respect to each predetermined reading unit, a predetermined latency occurs when the predetermined reading unit is changed. In FIG. 2, the bus interface overhead processing time is assumed to be 7 clock cycles.

The transmission time is obtained by dividing the number of bits of data to be read from a row of the external memory 11 by a bus bandwidth. The bus bandwidth relates to the number of bits that can be transmitted by a data transmission path between the external memory 11 and the compression unit 12, i.e., a bus, during a single clock cycle. The bus bandwidth is assumed to be 32 bits. Thus, when 4 pixels, i.e., 4-byte (32-bit) image data is to be read from a row of the external memory 11, the transmission time is 32/32, i.e., one clock cycle.

FIG. 3 is a related art timing diagram showing the time required for reading image data from the external memory 11 and performing motion compensation.

When image data of a previous frame is stored in the external memory 11, the compression unit 12 accesses the external memory 11 four times to read image data of a previous frame stored in the external memory 11 corresponding to a 4×4 current sub-block. This is because image data of each row of the 4×4 current sub-block is stored in different rows of the external memory 11. In this case, a total read clock cycle Tc1 required for reading 4×4 image data of the previous frame referred to by the 4×4 current sub-block is calculated as follows:
Tc1={(7+1)×4}=32 cc(clock cycle)

As mentioned above, the bus interface overhead processing time is 7 cc, the transmission time required for reading four pixels stored in a row of the external memory 11 is 1 cc, and four accesses to the external memory 11 are required to read image data of 4 rows of the previous frame.

From the foregoing equation, it can be seen that 16×Tc1, i.e., 512 cc, is required for extracting image data of a previous frame corresponding to sixteen 4×4 blocks included in one macroblock. When the time required for motion compensation with respect to a single 4×4 block is 9 cc and motion compensation may be performed in parallel with a read operation, the time required for reading image data from the external memory 11 for motion compensation of sixteen 4×4 blocks included in a single macroblock and performing motion compensation is 521 cc as illustrated in FIG. 3.

According to the related art, when motion compensation is performed in units of a 4×4 block divided from a macroblock, pixels in a row of the macroblock are stored in differential rows of the external memory 11. As a result, at least four accesses to the external memory 11 are required to read image data of a previous frame used for motion compensation of each 4×4 block, increasing the entire processing time required for compression encoding of an image.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an external memory device, a method of storing image data for the same, and an image processor using the method, in which the time required for compression-encoding and/or decoding an image can be reduced by minimizing the number of accesses to an external memory that stores a reference frame in image processing.

The present invention also reduces an operating frequency and the amount of power consumption by minimizing the number of accesses to an external memory.

According to an aspect of the present invention, there is provided a method of storing image data used for compression-encoding and/or decoding of an image in an external memory. The method includes forming image data included in a predetermined-size sub-block divided from a macroblock as at least one data storage unit and storing the data storage unit in the external memory.

According to another aspect of the present invention, there is provided an external memory device which stores image data used for compression-encoding and/or decoding of an image. The external memory device stores image data as at least one data storage unit, the image data being included in a predetermined-size sub-block divided from a unit block that is the unit of processing for compression-encoding and/or decoding of the image.

According to still another aspect of the present invention, there is provided an image processor which compression-encodes and/or decodes an image. The image processor includes an external memory, a memory control unit, and an image processing unit. The external memory stores externally input image data and image data of a previously-processed reference frame. The memory control unit forms image data included in a predetermined-size sub-block divided from a macroblock as at least one data storage unit and controls the image data to be written to or read from the external memory for each data storage unit. The image processing unit transmits a request for the image data to the memory control unit, receives the image data read under the control of the memory control unit, and performs encoding and/or decoding on the image.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a related art video encoder;

FIG. 2 is a view for explaining storage of image data in an external memory of the related art video encoder;

FIG. 3 is a timing diagram showing the time required for reading image data from the external memory of the related art video encoder and performing motion compensation;

FIG. 4 is a block diagram of an image processor according to an exemplary embodiment of the present invention;

FIG. 5 illustrates the structure of an external memory of FIG. 4 that stores 4×4 sub-blocks according to an exemplary embodiment of the present invention;

FIG. 6 illustrates the structure of the external memory of FIG. 4 that stores 8×8 sub-blocks according to an exemplary embodiment of the present invention;

FIG. 7 is a block diagram of a video encoder as an exemplary embodiment of an image processing unit of FIG. 4;

FIG. 8 is a timing diagram showing the time required for reading image data from the external memory and performing motion compensation according to an exemplary embodiment of the present invention; and

FIG. 9 is a flowchart illustrating a method of storing image data in the external memory according to an exemplary embodiment of the present invention.

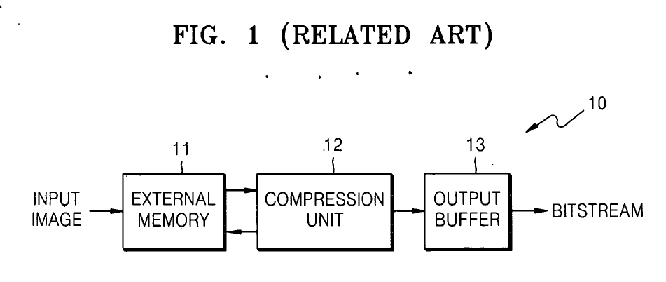

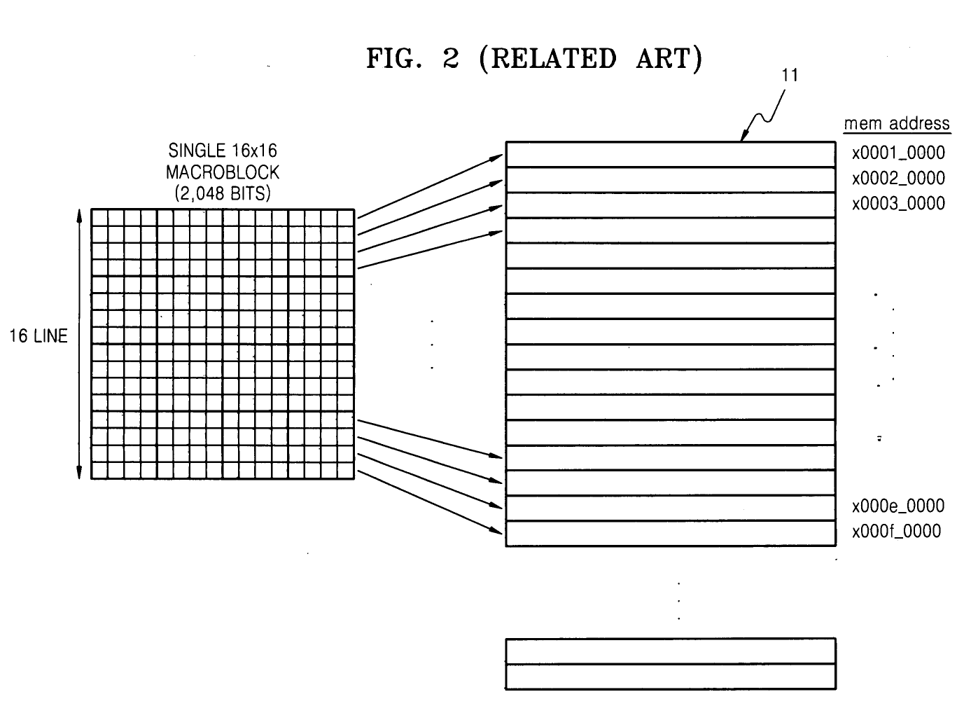

### DETAILED DESCRIPTION OF EXEMPLARY EMBODIMENTS OF THE INVENTION

Hereinafter, exemplary embodiments of the present invention will be described with reference to the accompanying drawings.

FIG. 4 is a block diagram of an image processor according to an exemplary embodiment of the present invention.

Referring to FIG. 4, the image processor includes an external memory 400, a memory control unit 520, and an image processing unit 530. The memory control unit 520 and the image processing unit 530 may be included in a single system-on-chip (SOC) 500. The image processor has a structure for a mutual data interface with the external memory 400 through the memory control unit 520. A video encoder that performs motion estimation, motion compensation, discrete cosine transform (DCT), quantization, and entropy-encoding or a video decoder that performs decoding by processing image data through an inverse process to encoding may be used for the image processing unit 530.

The image processing unit 530 transmits a request for reading or writing image data required for encoding or decoding of image data to the memory control unit 520.

The memory control unit 520 controls an operation of writing image data to or reading image data from the -external memory 400 in predetermined data units in response to the request. More specifically, the memory control unit 520 forms image data included in a predetermined-size sub-block divided from a macroblock as a single data storage unit in the external memory 400 and controls write and read operations such that the image data included in the sub-block is provided as being included in the single data storage unit of the external memory 400. In this way, the memory control unit 520 reduces the number of accesses to the external memory 400 when the image processing unit 530 performs motion estimation and motion compensation in units of a sub-block. Here, the single data storage unit relates to the unit of reading corresponding to one address of the external memory 400 and may be a single row of the external memory 400.

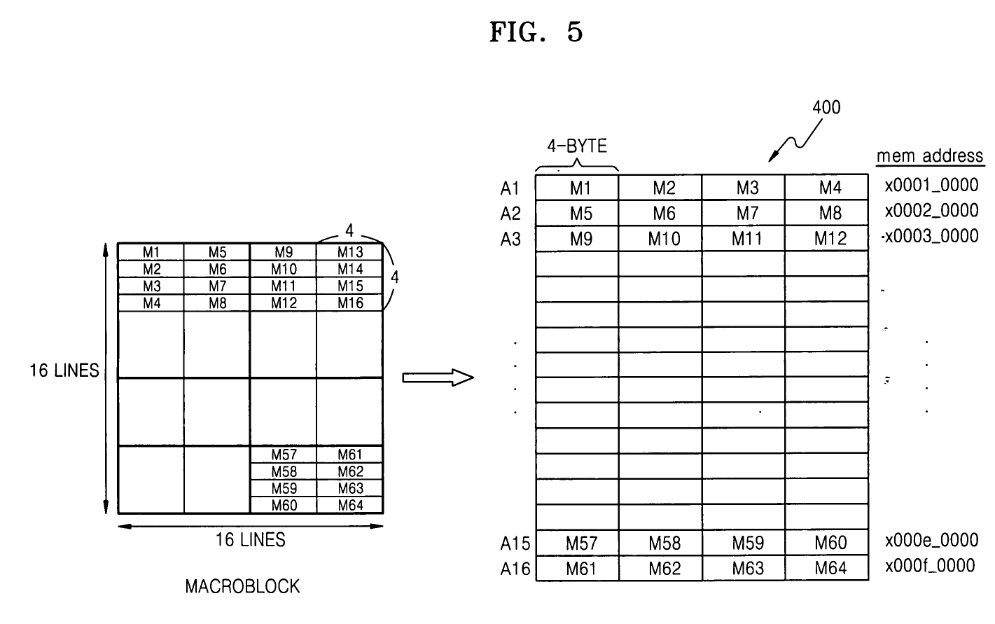

FIG. 5 illustrates the structure of the external memory 400 of FIG. 4 that stores 4×4 sub-blocks according to an exemplary embodiment of the present invention. In FIG. 5, M1 through M64 each indicate a row of a 4×4 sub-block, i.e., four pixels. In addition, the size of data that can be stored in a row of the external memory 400 is assumed to be 16 bytes.

Referring to FIG. 5, a predetermined-size sub-block divided from a macroblock is stored in a single row of the external memory 400. More specifically, four rows of a 4×4 block are successively stored in a row of the external memory 400 corresponding to a single address. For example, four rows M1, M2, M3, and M4 of a 4×4 sub-block at the top left comer of the macroblock are successively stored in a row A1 of the external memory 400. Here, an address corresponding to the row A1 is assumed to be x0001_{—}0000. As mentioned above, according to the related art, a row of a macroblock, instead of rows of a sub-block, is stored in a row of an external memory. In other words, according to the related art, pixels of M1, M5, M9, and M13 are stored in a row of the external memory 400, i.e., in a single read unit.

In general, motion estimation and motion compensation in image processing require largest computation and memory accesses. When motion compensation is performed on a 4×4 sub-block using the external memory 400 according to an exemplary embodiment of the present invention, image data of a reference frame required for motion compensation of the 4×4 sub-block can be extracted by reading only image data stored in a row of the external memory 400 without a need to read image data stored in four rows of the external memory 400 as in the related art, thereby reducing the number of accesses to the external memory 400.

When the size of data that can be stored in a row of the external memory 400 is changed, the number of accesses to the external memory 400 can be reduced by successively storing image data of the 4×4 sub-block in the external memory 400.

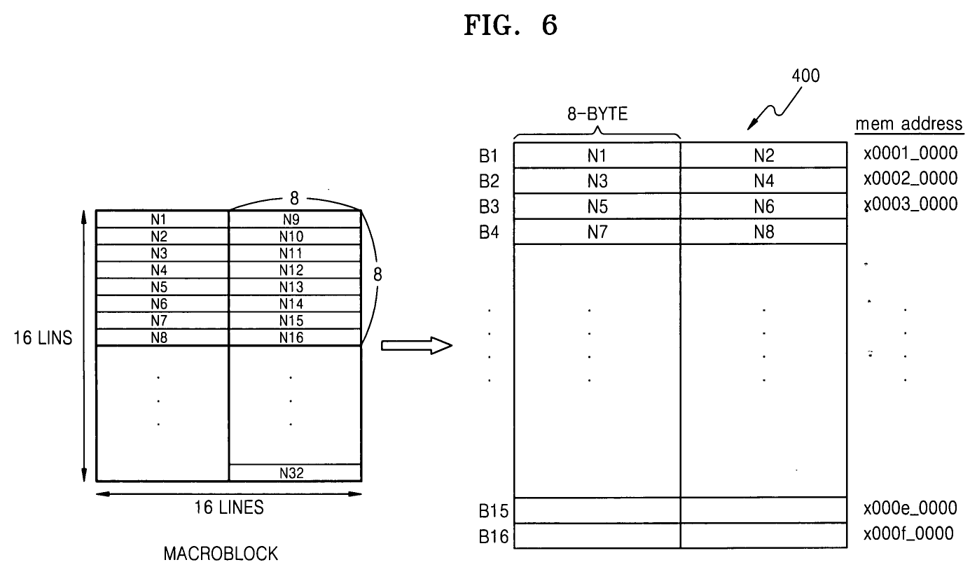

FIG. 6 illustrates the structure of the external memory 400 of FIG. 4 that stores 8×8 sub-blocks according to an exemplary embodiment of the present invention. In FIG. 6, N1 through N32 each indicate a row of an 8×8 sub-block, i.e., 8 pixels.

Referring to FIG. 6, pixels of an 8×8 sub-block divided from a macroblock are stored in successive rows B1 through B4 of the external memory 400. In FIG. 6, the size of data that can be stored in a single row of the external memory 400 is assumed to be 16 bytes. In this case, two of eight rows of an 8×8 sub-block are stored in a row of the external memory 400, i.e., a single data storage unit, corresponding to a single address. For example, N1 and N2 of an 8×8 sub-block at the top left corner of the macroblock are stored in the first row B1 of the external memory 400, N3 and N4 are stored in the second row B2 of the external memory 400, N5 and N6 are stored in the third row B3 of the external memory 400, and N7 and N8 are stored in the fourth row B4 of the external memory 400. In this way, pixels in eight rows N1 through N8 of an 8×8 sub-block are stored in four rows B1 through B4 of the external memory 400. As stated above, since a row of a macroblock is stored in a row of an external memory according to the prior art, image data in at least 8 rows should be read to read image data for an 8×8 sub-block stored in the external memory. However, according to the present invention, image data of a reference frame required for motion estimation and motion compensation of an 8×8 block can be read by reading image data in four rows of the external memory.

As such, even when image data included in an 8×8 sub-block divided from a macroblock cannot be stored in a row of the external memory 400, it is formed as at least one data storage unit and is stored in successive rows of the external memory 400, thereby reducing the number of accesses to the external memory 400 to read image data of a reference frame required for motion estimation and motion compensation of the 8×8 sub-block.

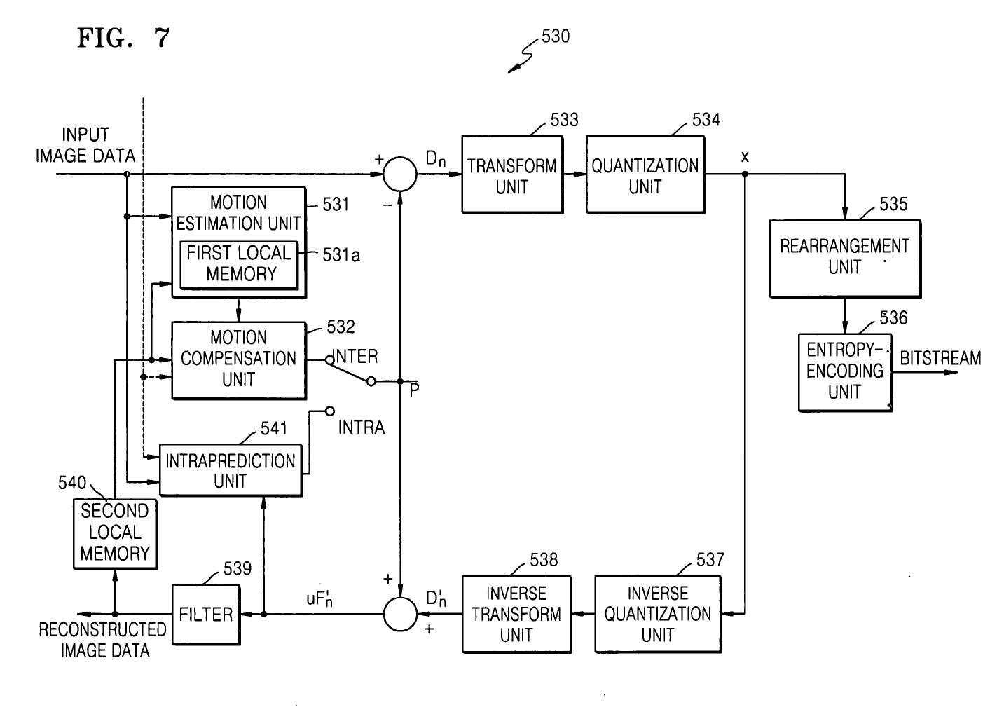

FIG. 7 is a block diagram of a video encoder as an example of the image processing unit 530 of FIG. 4.

Referring to FIG. 7, the image processing unit 530 includes a motion estimation unit 531, a motion compensation unit 532, a transform unit 533, a quantization unit 534, a rearrangement unit 535, an entropy-encoding unit 536, an inverse quantization unit 537, an inverse transform unit 538, a filter 539, a second local memory 540, and an intraprediction unit 541. The motion estimation unit 531 may include a first local memory 531a for temporarily storing image data for motion estimation.

For interprediction, the motion estimation unit 531 searches for a prediction value of a current macroblock in a reference picture. To obtain image data of a reference frame required for motion estimation, the motion estimation unit 531 reads the required image data from the second local memory 540 or transmits a request for the required image data to the memory control unit 520. Here, the reference frame may be a past or future frame or a previously encoded and transmitted frame.

The motion estimation unit 531 searches in an area of the reference frame for an area that is matched to a predetermined-size block. The predetermined-size block may be a 16×8, 8×16, 8×8, or 4×4 block divided from a macroblock in the case of tree-structured motion compensation according to the H.264 standard. More specifically, the motion estimation unit 531 compares a predetermined-size current block of a current frame and a block in a predetermined search area extending from the current block to search for the best matching area. Here, the motion estimation unit 531 selects a candidate area which minimizes a residual energy obtained by subtracting the candidate area from the current block as the best matching area. As a result of the motion estimation, a motion vector indicating the position of the best matching area is calculated.

The motion compensation unit 532 generates a residue by subtracting the best matching area extracted from the reference frame from the current block using the motion vector. Since data is stored in the external memory 400 according to an exemplary embodiment of the present invention in units of a predetermined-size block, the number of accesses of the motion compensation unit 532 to the external memory 400 can be reduced.

The residue generated through motion compensation undergoes transform and quantization through the transform unit 533 and the quantization unit 534. The quantized residue passes through the rearrangement unit 535 to be encoded by the entropy-encoding unit 536. The picture quantized to obtain a reference picture used for interprediction passes through the inverse quantization unit 537 and the inverse transform unit 538, thereby reconstructing a current picture. The reconstructed current picture passes through the filter 539 that performs deblocking filtering and is stored in the second local memory 540 or the external memory 400 for use in interprediction, i.e., motion estimation and motion compensation of a next picture.

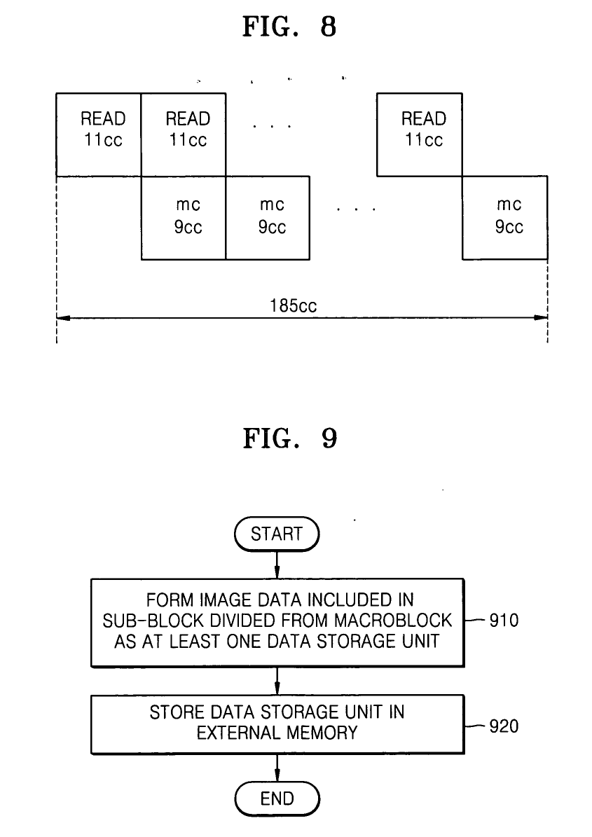

FIG. 8 is a timing diagram showing the time required for reading image data from the external memory 400 and performing motion compensation according to an exemplary embodiment of the present invention.

The image processing unit 530 can read image data of a reference frame corresponding to a 4×4 current sub-block through a single access to the external memory 400.

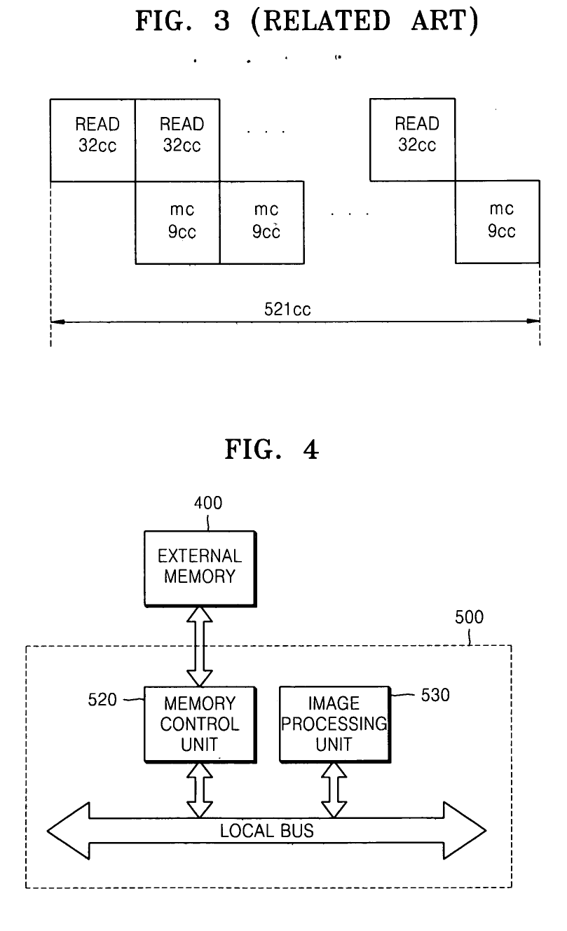

A total read clock cycle Tc2 required for reading 4×4 image data of a previous frame from the external memory 400 according to an exemplary embodiment of the present invention is as follows:
Tc2=7+4=11 cc,
where 7 cc is a bus interface overhead processing time and 4 cc is a transmission time required for reading 128 bits corresponding to 16 pixels stored in a row of the external memory 400 when a bus bandwidth is 32 bits. Thus, 16×Tc2, i.e., 176 cc is required for extracting image data of a reference frame corresponding to sixteen 4×4 sub-blocks included in a single macroblock. When the time required for motion estimation of a single 4×4 sub-block is 9 cc and the motion compensation can be performed in parallel with the read operation, the time required for extracting image data from the external memory 400 for motion compensation of sixteen 4×4 sub-blocks included in a single macroblock and performing motion compensation is 185 cc as illustrated in FIG. 8. Thus, it can be seen that a processing speed is improved by about 50% compared to the prior art illustrated in FIG. 3.

FIG. 9 is a flowchart illustrating a method of storing image data in the external memory 400 according to an exemplary embodiment of the present invention.

Referring to FIG. 9, in operation 910, the memory control unit 520 forms image data included in a predetermined-size sub-block divided from a macroblock of image data of a previously-processed reference frame as at least one data storage unit.

In operation 920, the memory control unit 520 stores the data storage unit in the external memory 400 to control image data to be written or read for each predetermined-size sub-block at the request of the image processing unit 530.

According to exemplary embodiments of the present invention, when image data of a reference frame used for motion estimation and motion compensation of a predetermined-size sub-block divided from a macroblock, e.g., a 4×4 sub-block, is extracted, the number of accesses to an external memory can be reduced and thus, the amount of computation and the amount of power consumption for image processing can be reduced. In particular, an external memory device according to an exemplary embodiment of the present invention prevents excessive overhead of a bus interface and reduces the amount of computation and the amount of power consumption for motion estimation and motion compensation when being applied to a motion estimation and motion compensation module using a pipeline method, thereby reducing a processing time required for image encoding or decoding.

As described above, according to exemplary embodiments of the present invention, the number of accesses to an external memory in image processing can be reduced, thereby reducing the amount of computation and the amount of power consumption in image processing.

Moreover, according to exemplary embodiments of the present invention, the use of a bus bandwidth between an external memory and an image processing unit can be optimized.

The present invention can also be embodied as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves. The computer-readable recording medium can also be distributed over network coupled computer systems so that the computer-readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of storing image data used for compression encoding or decoding of an image in a memory, the method comprising:
forming image data included in a sub-block divided from a macroblock as at least one data storage unit; and
storing the data storage unit in the memory.

2. The method of claim 1, wherein the data storage unit is formed by connecting rows of the sub-block.

3. The method of claim 1, wherein the data storage unit is stored in a single row of the memory corresponding to a single address.

4. The method of claim 1, wherein the sub-block is one of a 4×4 sub-block and an 8×8 sub-block.

5. The method of claim 1, wherein the image data indicates pixel values of pixels of the image.

6. The method of claim 1, wherein the image data is derived from a reference frame used for motion estimation and motion compensation of the sub-block.

7. A memory device which stores image data used for compression-encoding or decoding of an image, wherein the memory device stores image data as at least one data storage unit, the image data being included in a sub-block divided from a unit block that is a unit of processing for compression encoding or decoding of the image.

8. The memory device of claim 6, wherein the data storage unit is formed by connecting rows of the sub-block.

9. The memory device of claim 6, wherein the data storage unit is stored in a single row of the memory corresponding to a single address.

10. The memory device of claim 6, wherein the sub-block is one of a 4×4 sub-block and an 8×8 sub-block.

11. The memory device of claim 6, wherein the image data indicates pixel values of pixels of the image.

12. The memory device of claim 6, wherein the image data is derived from a reference frame used for motion estimation and motion compensation of the sub-block.

13. An image processor which compression encodes or decodes an image, the image processor comprising:
a memory which stores externally input image data and image data of a previously-processed reference frame;
a memory control unit which forms image data included in a sub-block divided from a macroblock as at least one data storage unit and controls the image data to be written to or read from the memory for each data storage unit; and
an image processing unit which transmits a request for the image data to the memory control unit, receives the image data read under the control of the memory control unit, and performs encoding or decoding on the image.

14. The image processor of claim 11, wherein the data storage unit is formed by connecting rows of the sub-block.

15. The image processor of claim 11, wherein the data storage unit is stored in a single row of the memory corresponding to a single address.

16. The image processor of claim 11, wherein the sub-block is one of a 4×4 sub-block and an 8×8 sub-block.

17. The image processor of claim 11, wherein the image data indicates pixel values of pixels of the image.

18. The image processor of claim 11, wherein the image data is derived from a reference frame used for motion estimation and motion compensation of the sub-block.
